(19) United States
(12) Patent Application Publication
(10) Pub. No.: US 2016/0226071 A1
(43) Pub. Date: Aug. 4, 2016

(54) LITHIUM-ION BATTERY AND METHOD FOR PREVENTING THE DISSOLUTION OF METALS FROM A CATHODE OF SAID LITHIUM-ION BATTERY AND/OR DAMAGE TO AN SEI LAYER OF AN ANODE OF SAID LITHIUM-ION BATTERY

(71) Applicant: ROBERT BOSCH GMBH, Stuttgart (DE)

(72) Inventors: Joerg Ziegler, Rutesheim (DE); Marcus Wegner, Leonberg (DE); Joerg Thielen, Stuttgart (DE); Jens Grimminger, Leonberg (DE)

(21) Appl. No.: 15/021,038

(22) PCT Filed: Sep. 2, 2014
(86) PCT No.: PCT/EP2014/068545

§ 371 Date: Mar. 10, 2016

(30) Foreign Application Priority Data
Sep. 27, 2013 (DE) 10 2013 219 478.1

(51) Int. Cl. H01M 4/62; H01M 4/133; H01M 4/131; H01M 10/0525; H01M 10/0568

(52) U.S. Cl. CPC H01M 4/628; H01M 10/0525; H01M 10/0568; H01M 4/131; H01M 4/133; H01M 4/625; H01M 2004/027

(57) ABSTRACT

A lithium-ion battery having an anode, a cathode, a separator, and an electrolyte connected to the anode and to the cathode, encompassing at least one lithium salt as an electrolyte salt and one solvent solubilizing the lithium salt, wherein the lithium-ion battery contains at least one cation exchanger that can release Li⁺ and bind H⁺, and that is in contact with the electrolyte. A method is also described for preventing the dissolution of metals out of a cathode of a lithium-ion battery and/or damage to an SEI layer of an anode of the lithium-ion battery, encompassing bringing an electrolyte of the lithium-ion battery into contact with at least one cation exchanger that can release Li⁺ and bind H⁺.

### FIELD

The present invention relates to a lithium-ion battery. The present invention further relates to a method for preventing the dissolution of metals out of a cathode of a lithium-ion battery and/or damage to an SEI layer of an anode of the lithium-ion battery.

### BACKGROUND INFORMATION

In batteries of the conventional “rocking chair” type, in which a carbon material, for example graphite, is used, the material is capable, when charging is carried out, of intercalating (depositing) lithium ions at the deposition sites of its lattice planes constituted by carbon atoms in the form of six-membered rings. A lithium deposition or intercalation material such as LiCoO₂, LiNiO₂, or LiMn₂O₄ is typically used as an active cathode material; this is capable, during charging, of de-intercalating (displacing) the lithium ions out of their deposition sites, so that lithium ions migrate back and forth between the deposition electrodes during the charge/discharge cycles.

Typical electrodes of lithium-ion batteries of this kind encompass one or more lithium-containing electrolyte salts in a solvent. Examples of such electrolyte salts are LiClO₄, LiBF₄, LiAsF₆, LiCF₃SO₃, LiPF₆, and the like.

Lithium-ion batteries are subject, both in operation and during storage, to a certain degree of aging, i.e., the capacity of the battery decreases and/or its internal resistance increases. One possible reason for accelerated aging is the presence of protic substances in the electrolyte. The protic substances are produced, for example, by:
1. Residues of H₂O in the electrolyte. Decomposition of the conductive salt LiPF₆ results in the formation of HF according to reaction equation (1):

LiPF₆+H₂O->2HF+POF₃+LiF (1)
2. Thermal decomposition of the electrolyte. This can occur, for example, during operation and/or storage of the cells at at least 45° C.
3. Oxidative decomposition of the electrolyte at the cathode at high cathode potentials, i.e. in particular at high charge states.

The protic substances can trigger a number of reactions that shorten service life. Two examples may be recited:
1. Acids can attack and destroy the solid electrolyte interface (SEI) layer on the anode. The result is that a new SEI layer must be formed; this irreversibly consumes cyclable lithium. This results in a loss of capacity and possibly also in an increase in internal resistance due to formation of a thicker SEI layer.
2. Acids, especially including HF, cause the dissolution of metals out of the cathode. This can be, for example, dissolution of manganese out of LiMn₂O₄ in accordance with reaction equation (2):

4H⁺+2LiMn₂O₄->2Li⁺+Mn²⁺+3MnO₂+2H₂O (2)

This causes a loss in capacity on the cathode side. In addition, Mn²⁺ diffuses to the anode, where it damages the SEI layer.

### SUMMARY

An example lithium-ion battery according to the present invention, having an anode, a cathode, a separator, and an electrolyte connected to the anode and to the cathode, encompasses at least one lithium salt as an electrolyte salt and one solvent solubilizing the lithium salt; the solubilized electrolyte salt in particular can react with water to yield at least one hydrogen-containing acid. The lithium-ion battery contains at least one cation exchanger that can release lithium(I) cations and bind protons, and that is in contact with the electrolyte. By introduction of the proton-capturing cation exchanger into the lithium-ion battery, the damaging effect of protic substances is reduced or prevented and the service life of the lithium-ion battery is thus appreciably extended. The service life extension is based on the fact that the loss of capacity of the lithium-ion battery is reduced, and/or the rise in its internal resistance is reduced. In addition, the cell reacts less sensitively to fluctuations in the water content of the electrolyte during the process of manufacturing the lithium-ion battery, since hydrogen fluoride that is produced can be neutralized. The release of lithium(I) cations from the cation exchanger does not have a negative effect on the operation of the lithium-ion battery, since lithium(I) cations are present in any case in the electrolyte.

In a preferred embodiment of the present invention, the cation exchanger is a zeolite. In another preferred embodiment of the present invention, the cation exchanger is an organic polymer, in particular an ionomer, that encompasses ion-exchanging groups which are selected from the group consisting of sulfite groups (—SO₃), oxide groups (—O⁻), carboxyl groups (—COO⁻), and sulfide groups (—S⁻). It is particularly preferred that the organic polymer be a perfluorocarbon or a perfluoroether. A “perfluorocarbon” is understood according to the present invention as a carbon compound that, with the exception of the ion-exchanging groups, is substituted entirely with fluorine. A “perfluoroether” is understood according to the present invention as a perfluorocarbon in which at least one carbon atom is replaced by an oxygen atom. Alternatively, it is particularly preferred that the organic polymer have, besides the ion-exchanging groups, further residues having an electron-attracting or electron-repelling effect, in order to influence the exchange capability of the ion-exchanging groups. Very particularly preferably, the cation exchanger is an organic polymer based on 2-[1-[difluoro[(trifluoroethenyl)oxy]methyl]-1,2,2,2-tetrafluoroethoxy]-1,1,2,2-tetrafluoroethanesulfonic acid. The advantage of this embodiment is the very good ability of the cation exchanger to bond chemically to the other components.

The exchange of protons for lithium(I) cations requires that the cation exchanger be in contact with the electrolyte. In an embodiment of the invention it is preferred for this purpose that the separator be impregnated with the cation exchanger. In another embodiment of the present invention, it is preferred that the separator be made of the cation exchanger, or that the cation exchanger be integrated as a copolymer into the separator. If the cation exchanger is implemented as a copolymer, then besides the copolymerization units that function as cation exchangers, monomers, oligomers, or polymer units based on known separator polymers are preferred for copolymerization. In yet another embodiment of the present invention, it is preferred that the cation exchanger be integrated into the cathode or into the anode. It is particularly preferred here that the cation exchanger be integrated into a polymer network of a binder in the cathode or in the anode. The very good chemical attachment of the cation exchanger to the separator, the anode, and/or the cathode is advantageous here.

The anode encompasses, in particular, carbon (for example in the form of amorphous non-graphite coke or graphite, preferably graphite), in which lithium ions can reversibly deposit, applied onto a conductive material. Alloys of lithium with silicon or tin, optionally in a carbon matrix, lithium metal, and lithium titanate are also particularly suitable. Very high capacities with optimum energy density can thereby be attained.

The cathode encompasses in particular a current collector, an active cathode material, an electrically conductive material, and a binder. For example, a mixture of an active cathode material, and powdered carbon to improve conductivity, is applied onto a foil made of a conductive material such as Ni, Ti, Al, Pt, V, Au, Zn, or alloys thereof. A suitable active cathode material furthermore contains cyclable lithium. It is preferably selected from the group of lithium compounds having a layer structure, for example lithium cobalt oxide (LiCoO₂), lithium nickel oxide (LiNiO₂), lithium cobalt nickel oxide (LiNi₁₋ₓCoₓO₂), lithium nickel cobalt manganese oxide (LiNi_{1-x-y}CoₓMn_{y}O₂), lithium nickel cobalt aluminum oxide (LiNiₓCo_{y}Al_{1-x-y}O₂), lithium manganese oxide (LiMnO₂), from the group of lithium-containing spinels, for example lithium manganese oxide (LiMn₂O₄), mixed oxides of lithium manganese oxide (LiMₓMn₂₋ₓO₄), and from the group of lithium-containing olivines, for example lithium iron phosphate (LiFePO₄). Lithium cobalt oxide, lithium nickel oxide, lithium cobalt nickel oxide, lithium nickel cobalt manganese oxide, lithium nickel cobalt aluminum oxide, lithium manganese oxide, lithium iron phosphate, and lithium manganese phosphate are particularly preferred.

The electrolyte encompasses in particular a nonaqueous aprotic organic solvent. Ethers, for example dimethoxymethane, dimethoxyethane, diethoxyethane, and tetrahydrofuran; carbonates, for example ethylene carbonate, propylene carbonate, dimethyl carbonate, diethyl carbonate, and ethyl methyl carbonate; or esters, for example ethyl acetate and γ-butyrolactone, are preferred. A solvent that encompasses a mixture of at least two of the carbonates ethylene carbonate, dimethyl carbonate, and ethyl methyl carbonate is particularly preferred.

Lithium(I) cations (Li⁺) with a Lewis acid anion, for example BF₄⁻, PF₆⁻, ClO₄⁻, CF₃SO₄⁻, or BPh₄⁻ (where Ph denotes a phenyl group), and mixtures of the aforementioned salts in one of the aforesaid aprotic solvents, are used in particular as electrolyte salts. LiPF₆ is preferably used as an electrolyte salt.

The method for decreasing the dissolution of metals out of a cathode of a lithium-ion battery and/or damage to an SEI layer of an anode of the lithium-ion battery encompasses bringing an electrolyte of the lithium-ion battery into contact with at least one cation exchanger that can release lithium(I) cations and bind protons. When this method is carried out on a conventional lithium ion battery, a lithium-ion battery according to the present invention is thereby obtained.

It is preferred that an electrode of the lithium-ion battery at which a protic substance is produced be ascertained, and that the cation exchanger preferably be integrated into that electrode. Protic substances in the lithium-ion battery can thereby be captured by the cation exchanger at the site where they are produced.

### BRIEF DESCRIPTION OF THE DRAWINGS

Exemplifying embodiments of the present invention are depicted in the figures and are explained in further detail below.

FIG. 1 shows a lithium-ion battery according to an example embodiment of the present invention.

FIG. 2 shows the structural formula of a cation exchanger that is in contact with an electrolyte in a lithium-ion battery according to an example embodiment of the present invention.

### DETAILED DESCRIPTION OF EXAMPLE EMBODIMENTS

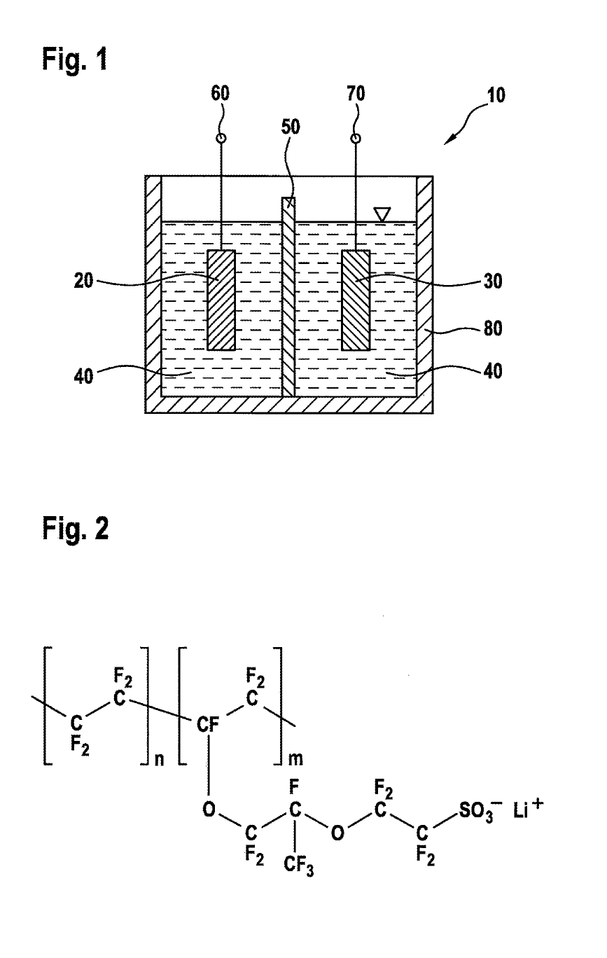

FIG. 1 depicts a general configuration of a lithium-ion battery 10 according to an example embodiment of the present invention. An anode 20 encompassing active anode material, and oppositely a cathode 30 encompassing active cathode material, are disposed in a housing 80. Disposed therebetween is a liquid electrolyte 40 that is in contact with anode 20 and cathode 30, and a separator 50 that prevents the occurrence of internal short circuits between electrodes 20 and 30 by spacing the two electrodes 20, 30 apart from one another and electrically insulating them from each other. Liquid electrolytes 40 typically encompass a solvent and a lithium-containing salt. Anode 20 is connected to an anode terminal 60, and cathode 30 to a cathode terminal 70.

The decrease in battery capacity over time depends on the active cathode material that is used. Whereas an appreciable decrease in capacity over time is to be observed with lithium manganese oxide as an active cathode material, that decrease is less with lithium cobalt oxide. This is attributed to the relative susceptibility of lithium manganese oxide to acid attack. With lithium manganese oxide, the corrosive attack of the compounds that are formed, e.g., the hydrogen-containing acid, results in further interactions of other components of the battery with the compounds that have formed, leading to a decrease in the quantity of available cyclable lithium and thus initiating a decrease in capacity. The observed decrease in the capacity of lithium-ion battery 10 over time can be attributed to undesired reactions between contaminants in electrochemical battery 10 and in cell components. Water is to be recited in particular as a contaminant.

It is not possible in practice to manufacture a battery 10 that is completely water-free. A residue of water remains in battery 10 in particular when the cell components do not merely contain water superficially, but instead the water is present in fixedly bound form. Even very small quantities of water react with an electrolyte salt solubilized in electrolyte 40, forming a hydrogen-containing acid. The hydrogen-containing acid that has been formed then reacts with the active cathode material, and this decomposes cathode 30. The acid decomposition of cathode 30 is accompanied by more formation of water (see reaction equation (2)). The water that is formed can then react with further solubilized electrolyte salt, generating further acid that further intensifies the acid environment and corrodes the active cathode material. On the one hand this results in a breakdown of the active cathode material, and on the other hand a decline in the ionic conductivity of electrolyte 40 is produced by the cumulative reaction of the electrolyte salt containing lithium ions.

A lithium-ion battery 10 having a cathode 30 encompassing a current collector, an active cathode material, a conductive material, and a binder is used in the present example embodiment of the present invention. A mixture of an active cathode material, and powdered carbon to improve conductivity, is applied onto a foil made of aluminum.

An anode 20 that is used encompasses graphite, in which lithium ions can reversibly deposit, applied onto a conductive material.

Electrolyte 40 of lithium-ion battery 10 according to the present invention encompasses a mixture of ethylene carbonate and dimethyl carbonate. Any water that may be present is removed to the greatest extent possible from this aprotic organic solvent mixture by rectification steps and drying steps prior to introduction into battery 10. A water content of less than or equal to 1 ppm to greater than or equal to 1000 ppm can nevertheless remain in the solvent. LiPF₆, which is easily solubilized in the mixture of ethylene carbonate and dimethyl carbonate, is used as an electrolyte salt.

It is desirable to use all constituents of a lithium-ion battery 10 in as anhydrous a fashion as possible, although this may not be entirely possible. A residual water content may remain in a lithium-ion battery 10. The residual water content, which gets into the battery principally via the electrolyte encompassing electrolyte salt and solvent, and via water adhering to the surfaces of the separator and electrodes, is in a range from greater than or equal to 10 to less than or equal to 1000 ppm. This residual content depends on the cell chemistry used, and on the manufacture of the battery. The water that is present initiates the above-described interactions with the battery components. For example, the lithium electrolyte salt LiPF₆ tends to interact strongly with water according to reaction equation (1), forming hydrogen fluoride (HF).

The hydrogen fluoride that is generated, because of its good solubility, is normally present in solution in the electrolyte. It is assumed that POF₃ likewise goes into solution, thereby causing the formation of phosphoric acid. The acids that are formed corrode the active cathode material with the result that, for example, Li ions and Mn ions are removed from it.

According to the present invention, lithium-ion battery 10 encompasses a cation exchanger that, in an embodiment of the invention, is applied as an impregnation onto separator 50.

In an example embodiment of the present invention the cation exchanger is lithium-Nafion® (E.I. DuPont de Nemours and Company). The structural formula of lithium-Nafion® is depicted in FIG. 2. This is an organic polymer based on 2-[1-[difluoro[(trifluoroethenyl)oxy]methyl]-1,2,2,2-tetrafluoroethoxy]-1,1,2,2-tetrafluoroethanesulfonic acid, in which n and m mutually independently assume values of more than 1. The exchange of lithium(I) cations of the lithium-Nafion with protons of hydrogen fluoride formed in accordance with reaction equation (1) occurs in accordance with reaction equation (3):

R—SO₃⁻Li⁺+H⁺->R—SO₃⁻H—SO₃⁻H⁺+Li⁺ (3),

where R denotes the organic residue of lithium-Nafion®.

In a further example embodiment of the lithium-ion battery according to the present invention, a lithium zeolite is used instead of lithium-Nafion®.

In an example embodiment of the example method according to the present invention for preventing the dissolution of metals out of cathode 30 of lithium-ion battery 10 and/or damage to the SEI layer of anode 20 of lithium-ion battery 10, electrolyte 40 is brought into contact with at least one cation exchanger that can release lithium(I) cations and bind protons. For this, firstly a determination is made as to that electrode 20, 30 of lithium-ion battery 10 at which the lithium salt LiPF₆ solubilized in the solvent reacts with water in accordance with reaction equation (1) to yield HF. The cation exchanger is then integrated into that electrode 20, 30. The hydrogen fluoride formed in accordance with reaction equation (1) can thereby be captured, at the site where it is produced, by the cation exchanger.

1-10. (canceled)

11. A lithium-ion battery comprising an anode, a cathode, a separator, and an electrolyte connected to the anode and to the cathode, the lithium-ion battery including at least one lithium salt as an electrolyte salt and one solvent solubilizing the lithium salt, wherein the lithium-ion battery contains at least one cation exchanger that can release lithium(I) cations and bind protons, and that is in contact with the electrolyte.

12. The lithium-ion battery as recited in claim 11, wherein the cation exchanger is a zeolite.

13. The lithium-ion battery as recited in claim 11, wherein the cation exchanger is an organic polymer that encompasses ion-exchanging groups which are selected from the group consisting of sulfite groups, oxide groups, carboxyl groups, and sulfide groups.

14. The lithium-ion battery as recited in claim 13, wherein the organic polymer is a perfluorocarbon or a perfluoroether.

15. The lithium-ion battery as recited in claim 11, wherein the separator is impregnated with the cation exchanger.

16. The lithium-ion battery as recited in claim 11, wherein one of: i) the separator is made of the cation exchanger, or ii) the cation exchanger is integrated as a copolymer into the separator.

17. The lithium-ion battery as recited in claim 11, wherein the cation exchanger is integrated into one of the cathode or the anode.

18. The lithium-ion battery as recited in claim 17, wherein the cation exchanger is integrated into a polymer network of a binder in one of the cathode or the anode.

19. A method for preventing the dissolution of metals out of a cathode of a lithium-ion battery and/or damage to an SEI layer of an anode of the lithium-ion battery, comprising:
bringing an electrolyte of the lithium-ion battery into contact with at least one cation exchanger that can release lithium(I) cations and bind protons.

20. The method as recited in claim 19, wherein an electrode of the lithium-ion battery at which a protic substance is produced is ascertained, and the cation exchanger is integrated into the electrode.
